(19) United States
(12) Patent Application Publication
(10) Pub. No.: US 2026/0095271 A1
(43) Pub. Date: Apr. 2, 2026

(54) Monitoring and Selecting a Stable and Best PTP Master in a Packet Network

(71) Applicant: Ciena Corporation, Hanover, MD (US)

(72) Inventors: Ankur Saxena, Bangalore (IN); Sharad Kumar Srivastava, Varanasi (IN)

(73) Assignee: Ciena Corporation, Hanover, MD (US)

(21) Appl. No.: 18/944,090

(22) Filed: Nov. 12, 2024

(30) Foreign Application Priority Data
Sep. 30, 2024 (IN) 202411073717

(51) Int. Cl. H04J 3/06; H04L 41/0668

(52) U.S. Cl. CPC H04J 3/0667; H04J 3/0641; H04J 3/0644; H04L 41/0668

(57) ABSTRACT

A network element in a packet network includes circuitry configured to communicate with a master clock for Precision Time Protocol (PTP), monitor one or more of link stability to the master clock, errors in packets to the master clock, and clock class stability of the master clock; and perform a Best Master Clock Algorithm (BMCA) based on the monitored one or more of the link stability, the errors, and the clock class stability. The BMCA is further performed based on one or more of loss of synchronization messages, loss of announce messages, loss of follow up messages, unusable timing information, and a holdover mode.

### FIELD OF THE DISCLOSURE

The present disclosure relates generally to networking. More particularly, the present disclosure relates to systems and methods for monitoring and selecting a stable and best Precision Time Protocol (PTP) master in a packet network.

### BACKGROUND OF THE DISCLOSURE

Precision Time Protocol (PTP) is a network protocol defined by the IEEE 1588 standard that enables precise time synchronization across devices in a packet-switched network. In such networks, PTP achieves high-accuracy timing by exchanging timestamped messages between master and slave clocks, allowing devices to measure and compensate for delays introduced by the network. PTP is described in the IEEE 1588 standards, such as “IEEE Standard for a Precision Clock Synchronization Protocol for Networked Measurement and Control Systems,” in IEEE Std 1588-2019 (Revision of IEEE Std 1588-2008), 16 Jun. 2020, the contents of which are incorporated by reference in their entirety. This is generally referred to as IEEE 1588v2.x. The Best Master Clock Algorithm (BMCA) is a fundamental component of PTP that automates the selection of the most suitable clock to act as the grandmaster in the network. BMCA works by having each clock periodically send out Announce messages containing their clock quality attributes. Upon receiving these messages, each clock independently evaluates the attributes using a hierarchical set of criteria: starting with the Priority1 field, then clock class, clock accuracy, clock variance, Priority2 field, and finally the unique clock identity if necessary. By systematically comparing these attributes, each device determines the clock to act as the Grandmaster. This decentralized and dynamic selection process ensures that the network always synchronizes to the most accurate and reliable time source available, enhancing overall synchronization precision and robustness.

### BRIEF SUMMARY OF THE DISCLOSURE

The present disclosure relates to systems and methods for monitoring and selecting a stable and best Precision Time Protocol (PTP) master in a packet network. Having multiple master clocks with similar or identical priority levels and clock quality attributes can lead to flapping in the selection of the Grandmaster when using the BMCA. Flapping occurs because BMCA relies on each device (network element) independently evaluating the best master clock based on received Announce messages containing clock attributes. When multiple clocks are equally qualified, slight variations in network conditions or message timing can cause devices to alternately select different Grandmasters. This results in frequent changes in the Grandmaster selection, causing instability in time synchronization across the network. Such instability can degrade the performance of time-sensitive applications, as devices may constantly switch between master clocks, leading to synchronization errors and reduced network reliability. As such, the present disclosure enhances the BMCA algorithm to include additional attributes such as operational state and physical link statistics as inputs. This causes the BMCA algorithm to select not just the best Grandmaster, but the best stable Grandmaster. Any network device supporting IEEE 1588, ITU-T G.8275.1, or ITU-T G.8275.2 can implement the present disclosure to minimize transient events and BMCA reselections, leading to better synchronization which is critical in 5G and 5G New Radio (NR) applications.

In various embodiments, the present disclosure includes a method having steps, an apparatus with circuitry configured to implement the steps, and a non-transitory computer-readable medium storing instructions that, when executed, cause circuitry to perform the steps. The steps include communicating with a master clock for Precision Time Protocol (PTP); monitoring one or more of link stability to the master clock, errors in packets to the master clock, and clock class stability of the master clock; and performing a Best Master Clock Algorithm (BMCA) based on the monitored one or more of the link stability, the errors, and the clock class stability. The BMCA can be further performed based on one or more of loss of synchronization messages, loss of announce messages, loss of follow up messages, unusable timing information, and a holdover mode.

The monitored one or more of the link stability, the errors, and the clock class stability can each be a PTP Telecom Synchronization Fail (PTSF) alarm. The BMCA can be performed responsive to an alarm for the monitored one or more of the link stability, the errors, and the clock class stability. The BMCA can be performed based on the link stability where an alarm is raised when a quality issue of a link to the master clock is detected, and where the alarm is removed after a wait to restore time where the quality issue is not detected during the wait to restore time. The quality issue can be based on any of packet loss, latency, jitter, and throughput consistency.

The BMCA can be performed based on the errors which are Cyclic Redundancy Check (CRC) where an alarm is raised when a certain number of CRC errors are detected on a link to the master clock, and where the alarm is removed after a wait to restore time where the CRC errors not detected during the wait to restore time. The BMCA can be performed based on the clock class stability where an alarm is raised when a certain number of clock class flops are detected on the master clock, and where the alarm is removed after a wait to restore time where the clock class flops are not detected during the wait to restore time.

### BRIEF DESCRIPTION OF THE DRAWINGS

The present disclosure is detailed through various drawings, where like components or steps are indicated by identical reference numbers for clarity and consistency.

FIG. 1 illustrates a network diagram of a network having two grandmasters, T-GM-1, T-GM-2, for illustrating BMCA along with the additional details included therein for link stability, Cyclic Redundancy Check (CRC) errors, and master clock class.

FIG. 2 illustrates a block diagram of a network element, depicted in a simplified functional format.

FIG. 3 illustrates a block diagram of an example processing device.

FIG. 4 illustrates a flowchart of a process for monitoring and selecting a stable and best Precision Time Protocol (PTP) master in a packet network.

### DETAILED DESCRIPTION OF THE DISCLOSURE

Again, the present disclosure relates to systems and methods for monitoring and selecting a stable and best Precision Time Protocol (PTP) master in a packet network. Relevant standards include IEEE Standard 1588-2019, “IEEE Standard for a Precision Clock Synchronization Protocol for Networked Measurement and Control Systems,” Institute of Electrical and Electronics Engineers, ITU-T Recommendation G.8275.1 (2016), “Precision time protocol telecom profile for phase/time synchronization with full timing support from the network,” International Telecommunication Union, ITU-T Recommendation G.8275.2 (2016), “Precision time protocol telecom profile for phase/time synchronization with partial timing support from the network,” International Telecommunication Union, the contents of each are incorporated by reference in their entirety.

IEEE 1588 defines PTP, enabling precise synchronization of clocks across networked devices with sub-microsecond accuracy. The standard outlines the mechanisms for clock synchronization, including the exchange of timestamped messages and the BMCA algorithm for selecting the optimal master clock within a network. The 2019 revision of IEEE 1588 introduces enhancements like improved accuracy, robustness against network delays, and security features to protect against timing attacks. A grandmaster clock in a PTP network serves as the primary source of accurate time for all devices within that network. It is the topmost clock selected through the BMCA algorithm, which assesses all clocks based on criteria like priority levels, clock class, accuracy, and stability to determine the most qualified one. Once designated, the grandmaster clock distributes its precise time information to subordinate clocks by sending timestamped messages, ensuring that all devices are synchronized. ITU-T G.8275.1 specifies a PTP profile tailored for precise time and phase synchronization in telecom networks and includes modifications to the standard BMCA to suit telecommunication requirements. ITU-T G.8275.2 defines telecom profile for phase and time synchronization in networks that provide partial timing support, enabling accurate synchronization even when only some network elements are timing-aware.

Note, the terms master and grandmaster clock are related, but not identical. The grandmaster clock is the primary source of time for the entire network—the most accurate and stable clock selected through the BMCA. It sits at the top of the synchronization hierarchy and provides the reference time to all other clocks in the network. A master clock, on the other hand, is any clock that provides synchronization to one or more subordinate clocks (sometimes called slave or ordinary clocks). In hierarchical PTP networks, there can be intermediate master clocks that receive time from the grandmaster and distribute it downstream to other devices. These master clocks act as both slaves (to their upstream master or grandmaster) and masters (to their downstream slaves). Therefore, while all grandmaster clocks are master clocks, not all master clocks are grandmasters. The grandmaster is the ultimate master clock in the network, whereas master clocks can exist at various levels within the synchronization hierarchy.

A T-GM, or Telecom Grandmaster, is a specialized grandmaster clock used in telecommunications networks that implement PTP. Specifically defined in recommendations like ITU-T G.8275.1 and G.8275.2, the T-GM serves as the primary source of precise time and phase synchronization for telecom networks requiring high levels of accuracy. In the context of PTP, the T-GM distributes accurate timing information to downstream network elements such as Telecom Boundary Clocks (T-BCs) and Telecom Time Slave Clocks (T-TSCs). It interfaces with a highly accurate reference time source, typically a Global Navigation Satellite System (GNSS) like GPS. The T-GM then uses PTP to propagate this timing information across the network, ensuring that all devices are synchronized to the same precise time. The T-GM is designed to meet the stringent synchronization requirements of modern telecom applications, such as 4G LTE-Advanced and 5G networks.

BMCA is used to select both the grandmaster clock (i.e., the T-GM) and the master clocks. BMCA operates by having each device in the network exchange Announce messages containing their clock attributes. Based on these attributes, each device independently evaluates and determines the best clock to act as the grandmaster—the primary source of time for the entire network. In addition to selecting the grandmaster clock, BMCA also helps establish the hierarchical relationships between clocks at different levels. Devices like boundary clocks and ordinary clocks use BMCA to decide whether they should function as master or slave clocks relative to their neighbors. This means that BMCA is continually used to configure the roles of devices throughout the network, creating a synchronized hierarchy where master clocks provide timing to slave clocks downstream.

Of note, BMCA reacts on every event and is designed to always select best master or grandmaster. Specifically, BMCA operates continuously by having each clock regularly exchange Announce messages containing their clock attributes. Upon receiving these messages, each clock independently evaluates the potential masters using a hierarchical set of criteria defined by the BMCA. This evaluation process is ongoing, allowing each device to maintain an up-to-date understanding of the best available master clock. BMCA reacts to every event by dynamically adjusting to changes in the network. For instance, if a new clock with superior attributes joins the network, its Announce messages prompt other devices to recognize it as the new best master, leading them to reconfigure their synchronization accordingly. Conversely, if the current Grandmaster clock fails or its quality degrades, other clocks detect the absence or decline in its Announce messages and automatically select the next best master based on the BMCA criteria. This continual operation ensures that the network promptly responds to events like clock additions, removals, or fluctuations in clock performance, maintaining optimal synchronization across all devices.

If there are momentary failures, then BMCA switches to next available best master and can reselect old master after the failures clear, and these additional BMCA reselections may cause transients and convergence issues related to the synchronization.

The objective herein is to reduce network transients and convergence delays caused by T-GM reselection and restoration. Specifically, the BMCA is enhanced to consider additional inputs related to the operation state and statistics on physical links in the network, in addition to standard inputs related to clock stability. These additional inputs enhance BMCA to select the best and most stable master, rather than a better clock at the moment that is less stable. This enhancement helps 5G network operators in maintaining T-GM resiliency by selecting the stable and best T-GM considering network stability factors. This enhancement also helps in reducing network transients and network convergence delays caused by T-GM reselection and restoration.

In an example use case, 5G applications demand stringent time alignment across the radio elements, and PTP is the best solution to deliver the required timing accuracy over the packet-based network. Accordingly, PTP accuracy and performance has become a critical Key Performance Indicator (KPI) for the 5G network. It has been determined that network issues related to link stability, CRC errors, and the PTP master clock stability itself can cause a slave clock to flap or end up with PTP providing bad accuracy.

Long Term Evolution-Time Division Duplexing (TDD) (LTE-TDD) and 5G NR network timing accuracy requirements are in the nanosecond range, and debugging any PTP issue in a production network is complex. However, the consequences of operational problems are severe, having a high impact on service stability. With 5G adoption, PTP protocol stability and its capability to handle network failures has become a key demand of every network operator.

Today, ITU-T BMCA and Alternate BMCA algorithms are available to support master clock resiliency, however during selection of a master clock, they do not account if there are network issues like link instability, CRC errors, or frequent changes in PTP Master ClockClass parameter. Link instability and CRC errors can have a significant impact on the operation of BMCA. BMCA relies on the regular and reliable exchange of Announce messages and other PTP packets to evaluate and select the optimal master and grandmaster clocks for synchronization. If a network link is unstable or experiencing high CRC errors, PTP messages may be delayed, lost, or corrupted. This can cause devices to miss or misinterpret Announce messages, leading them to incorrectly assume that the current grandmaster is unavailable or that a better master clock has become available. As a result, the BMCA may trigger unnecessary re-elections of the grandmaster, causing frequent switching between master clocks-a phenomenon known as flapping. This instability disrupts the time synchronization across the network, potentially degrading the performance of time-sensitive applications and leading to synchronization errors.

Also, frequent changes in the PTP Master ClockClass parameter can significantly impact the operation of BMCA. The ClockClass parameter is a critical attribute that indicates a clock's quality and traceability to a primary time source; it plays a key role in BMCA's selection of the grandmaster clock. If a clock's ClockClass value fluctuates often-due to issues like intermittent GPS signals or instability in its reference time source-BMCA will continuously re-evaluate the hierarchy of clocks in the network. This can lead to frequent switching between master clocks, i.e., flapping, causing instability in time synchronization. Such instability can degrade the performance of time-sensitive applications by introducing synchronization errors and reducing overall network reliability.

Since these details are not considered in BMCA and its variants, it can lead to BMCA switching back and forth between primary and backup masters.

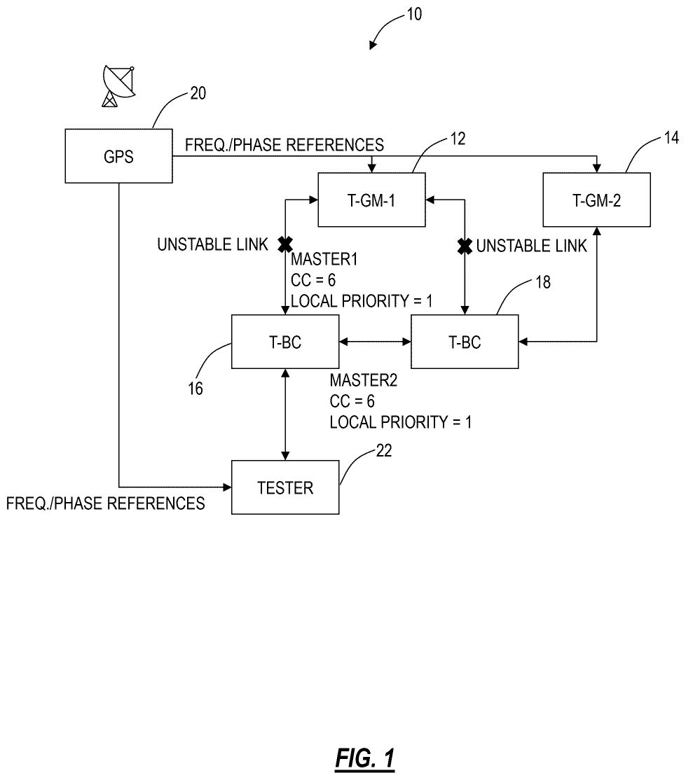

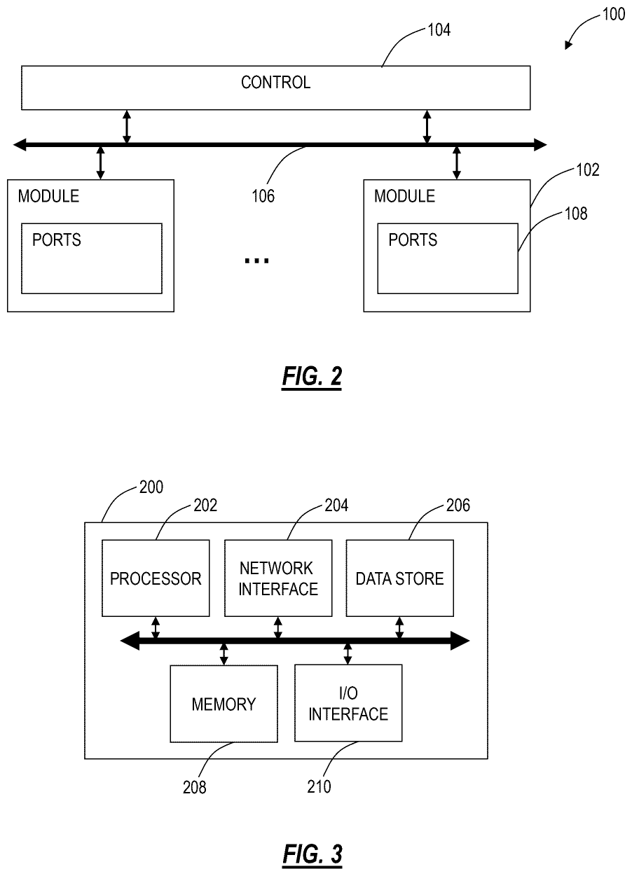

FIG. 1 illustrates a network diagram of a network 10 having two grandmasters, T-GM-1, T-GM-2, 12, 14, for illustrating BMCA along with the additional details included therein for link stability, CRC errors, and master clock class. The network 10 includes the T-GM-1 12 and the T-GM-2 14 and two T-BCs 16, 18, each of which can be at a network element in the network 10. FIG. 2 illustrates a diagram of a network element 100.

By deploying two T-GMs 12, 14, one can act as the primary time source while the other serves as a backup; if the primary fails, the BMCA automatically selects the backup, ensuring continuous synchronization. Additionally, having T-GMs 12, 14 in different locations can reduce latency and improve accuracy by allowing devices to sync with the nearest T-GM 12, 14. This setup also facilitates load balancing and enables network segments to operate independently during failures or maintenance. Proper configuration of BMCA priorities and careful network design are essential to prevent timing loops and ensure consistent synchronization across the network when multiple T-GMs are present.

The T-BCs 16, 18 connect to the T-GMs 12, 14 by receiving timing messages from the T-GM, adjusting for network delays, and synchronizing their local clocks. After synchronization, the T-BCs 16, 18 forward accurate timing information downstream to other devices or further T-BCs, ensuring that precise time is maintained across the network. In this example, the T-BC 18 connects to both the T-GMs 12, 14, whereas the T-BC 16 connects to the T-GM 12 and the T-BC 18. The T-BC 16 can select between the T-GM 12 and the T-BC 18 using BMCA. Additionally, GPS 20 can provide frequency and phase references to the T-GMs 12, 14 and a testing device 22 connected to the T-BC 16.

In this example, links between the T-GM 12 and the T-BCs 16, 18 are unstable. This can cause the T-BC 18 to flap between the T-GM 12 and the T-GM 14, as well as the T-BC 16 to flap between the T-GM 12 and the T-BC 18. This constant flapping between T-GM 12, 14 will cause not only transient jump but will also cause Timestamp jumps for PTP Servo algorithm on the T-BC 18 as the path to different PTP Masters may have different Link Asymmetries. Of note,

PTP Telecom Synchronization Fail (PTSF) alarms are used in PTP and in the BMCA. These alarms serve as indicators when a device experiences synchronization failures, prompting the BMCA to take appropriate actions to maintain network-wide timing accuracy. Here's how PTSF alarms interact with BMCA:
(1) Detection of Synchronization Issues: When a device (e.g., a Telecom Boundary Clock (T-BC) or Telecom Time Slave Clock (T-TSC)) experiences problems like loss of Sync messages or Announce messages, it raises PTSF alarms such as PTSF-lossSync or PTSF-lossAnnounce. These alarms indicate that the device can no longer maintain reliable synchronization with its current master clock.
(2) Re-Evaluation of the Clock Hierarchy: Once a PTSF alarm is raised, BMCA is triggered to re-evaluate the available master clocks. The BMCA checks whether a better master or grandmaster clock is available by comparing the clock attributes (e.g., ClockClass, priority levels, accuracy, stability) from the received Announce messages of other clocks in the network.
(3) Selection of a New Master: If the current master clock is deemed unusable (e.g., because it has stopped sending Announce messages or is providing inaccurate time), BMCA will select a new master or grandmaster based on the best available clock attributes. This ensures that the device can maintain synchronization even in the event of a failure.
(4) Fallback to a Backup Master: In cases where a grandmaster clock or upstream T-BC fails and a PTSF alarm is triggered, BMCA can select a backup master or grandmaster.

This process ensures network resilience and continuity of time synchronization by allowing devices to switch to a different clock when synchronization from the original source is lost.
(5) Continuous Monitoring and Recovery: BMCA continuously monitors the network, using PTSF alarms to detect issues in real time. If the original master clock recovers or a better one becomes available, BMCA will re-select the optimal master based on updated clock attributes, ensuring that devices always synchronize to the best possible source.

Existing PTSF alarms include:
(1) PTSF-lossSync: Loss of Sync messages.
(2) PTSF-lossAnnounce: Loss of Announce messages.
(3) PTSF-lossFollowUp: Loss of Follow_Up messages.
(4) PTSF-unusable: Unusable timing information.
(5) PTSF-holdover: Device in holdover mode.

An active PTSF alarm affects BMCA by indicating that the current master clock is no longer providing reliable synchronization, prompting the BMCA to re-evaluate the network's clock sources. The affected master is deprioritized or excluded from consideration, and BMCA searches for a new, more reliable master clock from the remaining available clocks. This ensures that the device maintains synchronization despite the failure. If multiple clocks are available, BMCA selects the best alternative, ensuring continuous network stability and accurate time synchronization.

The present disclosure adds three new PTSF alarms, which can be used individually or in combination with one another and with other PTSF alarms, to select a best stable master. The three new PTSF alarms include
(1) Link Stability (ptsf_linkstability)
(2) CRC errors on the link (ptsf_linkcrc)
(3) Master Clock class flap (ptsf_masterclkclass)

These alarms can be used individually or in combination with one another, along with the other PTSF alarms, i.e., PTSF-lossSync, PTSF-lossAnnounce, PTSF-lossFollowUp, PTSF-unusable, and PTSF-holdover. Specifically, these three new PTSF alarms are raised and used to dissuade BCMA from selecting a given clock when present, indicating stability issues either on the link (link stability or CRC errors) or on the clock (clock class flap).
(1) Link Stability (ptsf_linkstability)—This property indicates whether the physical link or network path towards each PTP Master is regarded as reliable. In an embodiment, the default value is FALSE meaning the physical link or network path is reliable, and it is set to TRUE as soon as a link down or link quality issue is detected. When the link is restored or the link quality improves, then a wait to restore timer is started.

Measuring link stability on a packet link involves assessing key factors like packet loss, latency, jitter, and throughput consistency. Those skilled in the art will appreciate there are various techniques to monitor packet loss, latency, jitter, and throughput consistency, all of which are contemplated herewith. These generally include test packets sent for measuring these aspects as well as heartbeat packets to monitor link continuity. Any method of detection of an issue in the network path is contemplated and can be done by using any existing protocols or any implementation specific method. For example, G.8275.2 uses PTP over Internet Protocol (IP) and that's why PTP layer may not be aware of the physical link used for PTP over IP packet transmission hence it will use some method to find out the link being used for PTP packet exchange. That physical link needs to be monitored for this PTSF.

Detection of link stability is considered as one or more failures in a specific time duration. This duration and number of failures can be configurable. When running, the wait to restore timer restarts if another link down or reliability issue is detected, otherwise the property ptsf_linkstability is set to FALSE on expiry. The wait to restore timer value can also be configurable.
(2) CRC errors on the link (ptsf_linkcrc)-CRC errors represent the number of packets arriving that failed the CRC check and are assumed to be corrupted. CRC is an error-detection mechanism used to ensure the integrity of data transmitted over a network. The sender generates a CRC value from the data using an algorithm and attaches it to the packet. Upon receipt, the receiver recalculates the CRC value from the data and compares it with the attached CRC. If the values match, the data is considered intact; if not, the packet is flagged as corrupted. CRC checks efficiently detect common transmission errors like bit flips, helping maintain data integrity with minimal overhead in real-time communication systems. Additionally, a device can use the reliability number for this purpose, which is a metric indicating the ratio of error free versus total packets.

In an embodiment, the default value for ptsf_linkcrc is FALSE, i.e., no CRC errors. There can be a threshold for CRC error in last n seconds. After detecting more than a certain number of CRC errors in the previous n seconds, the property ptsf_linkcrc is set to TRUE and the wait to restore timer is started. When the wait to restore timer is running, the timer restarts if CRC errors are again seen within n seconds, otherwise the property ptsf_linkcrc is set to FALSE on expiry.
(3) Master Clock class flap (ptsf_masterclkclass)—This property is maintained for every defined master, and, in an embodiment, it is set to TRUE as soon as a clock class flap is detected in the Announce message of that Master. At the same time, the wait to restore timer is started. When the wait to restore timer is running, this timer restarts if a clock class flap is again detected, otherwise the property ptsf_masterclkclass is set to FALSE on expiry.

Any change in the state of the properties in the three new PTSF alarms triggers the BMCA selection process to reselect a new stable master as the best. The BMCA only considers masters for selection that have the above PTSF properties set to FALSE. Of course, if all clocks have PTSF alarms, BMCA can select the clock with the least severe alarms.

FIG. 2 illustrates a block diagram of a network element 100, depicted in a simplified functional format. It is important to note that a more practical design of this router would likely include additional components and processing logic to accommodate standard operating features, which are not detailed here. The network element 100 may represent any network element operable in a network using optical and packet protocols, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the network element 100. It may also communicate with external network management systems or databases that handle provisioning and operational data.

Lastly, while FIG. 2 provides a basic view, those skilled in the art will understand that the network element 100 could include additional components or be configured differently, such as in a distributed arrangement or as an integrated, rack-mounted unit (often referred to as a “pizza-box” configuration). This depiction in FIG. 2 is intended to convey functional aspects, with actual hardware implementations varying widely.

The hardware configuration of a T-GM in the network element 100 is designed to serve as the primary source of precise time. It typically includes a highly accurate reference clock, such as a GPS/GNSS receiver or atomic clock, and an internal oscillator, such as a rubidium or oven-controlled crystal oscillator (OCXO), to maintain time during temporary losses of the external reference. The T-GM also includes time stamping units (TSUs) for generating and inserting accurate timestamps into PTP messages, ensuring sub-microsecond precision in time distribution. High-performance network interface cards (NICs) with multiple ports allow the T-GM to communicate with downstream devices, distributing time synchronization across the network, while synchronization control modules manage timing and monitor the system for issues, raising alarms when necessary. The T-BC, as an intermediary device, is configured to receive and forward timing messages from upstream clocks, such as the T-GM. It also includes time stamping units (TSUs) to adjust for delays and ensure accurate forwarding of timing data to downstream devices. T-BCs have high-performance network interfaces and built-in oscillators (typically TCXOs or OCXOs) to maintain time accuracy during brief disruptions. The hardware also includes packet-processing engines for low-latency handling of PTP messages and monitoring systems for detecting synchronization issues. Both T-GM and T-BC devices support redundancy and monitoring features like SNMP to ensure reliable time synchronization in telecom networks, where accuracy is critical.

FIG. 3 illustrates a block diagram of an example processing device 200. The processing device 200 may be integrated within the network element 100 or function as a standalone unit connected to the network element 100. It may also be known as an apparatus, a control module, shelf controller, shelf processor, or system controller. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, Operations, Administration, Maintenance, and Provisioning (OAM&P) data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

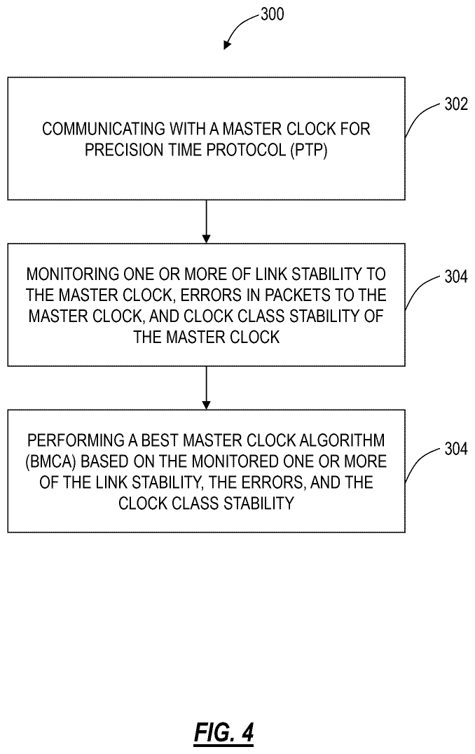

FIG. 4 illustrates a flowchart of a process 300 for monitoring and selecting a stable and best Precision Time Protocol (PTP) master in a packet network. The process 300 can be implemented as a) methods having steps, b) circuitry configured to implement the steps, c) a network element configured to implement the steps, and d) non-transitory computer-readable media storing instructions for programming one or more processors to execute the steps.

The steps include communicating with a master clock for Precision Time Protocol (PTP) (step 302); monitoring one or more of link stability to the master clock, errors in packets to the master clock, and clock class stability of the master clock (step 304); and performing a Best Master Clock Algorithm (BMCA) based on the monitored one or more of the link stability, the errors, and the clock class stability (step 306). The BMCA is further performed based on one or more of loss of synchronization messages, loss of announce messages, loss of follow up messages, unusable timing information, and a holdover mode. The monitored one or more of the link stability, the errors, and the clock class stability can each be a PTP Telecom Synchronization Fail (PTSF) alarm. The BMCA can be performed responsive to an alarm for the monitored one or more of the link stability, the errors, and the clock class stability.

In an embodiment, the BMCA is performed based on the link stability where an alarm is raised when a quality issue of a link to the master clock is detected, and where the alarm is removed after a wait to restore time where the quality issue is not detected during the wait to restore time. The quality issue can be based on any of packet loss, latency, jitter, and throughput consistency. In another embodiment, the BMCA is performed based on the errors which are Cyclic Redundancy Check (CRC) where an alarm is raised when a certain number of CRC errors are detected on a link to the master clock, and where the alarm is removed after a wait to restore time where the CRC errors not detected during the wait to restore time. In a further embodiment, the BMCA is performed based on the clock class stability where an alarm is raised when a certain number of clock class flops are detected on the master clock, and where the alarm is removed after a wait to restore time where the clock class flops are not detected during the wait to restore time.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. A network element in a packet network, the network element comprising circuitry configured to:
communicate with a master clock for Precision Time Protocol (PTP),
monitor one or more of link stability to the master clock, errors in packets to the master clock, and clock class stability of the master clock, and
perform a Best Master Clock Algorithm (BMCA) based on the monitored one or more of the link stability, the errors, and the clock class stability.

2. The network element of claim 1, wherein the BMCA is further performed based on one or more of loss of synchronization messages, loss of announce messages, loss of follow up messages, unusable timing information, and a holdover mode.

3. The network element of claim 1, wherein the monitored one or more of the link stability, the errors, and the clock class stability are each a PTP Telecom Synchronization Fail (PTSF) alarm.

4. The network element of claim 1, wherein the BMCA is performed responsive to an alarm for the monitored one or more of the link stability, the errors, and the clock class stability.

5. The network element of claim 1, wherein the BMCA is performed based on the link stability where an alarm is raised when a quality issue of a link to the master clock is detected, and where the alarm is removed after a wait to restore time where the quality issue is not detected during the wait to restore time.

6. The network element of claim 5, wherein the quality issue is based on any of packet loss, latency, jitter, and throughput consistency.

7. The network element of claim 1, wherein the BMCA is performed based on the errors which are Cyclic Redundancy Check (CRC) where an alarm is raised when a certain number of CRC errors are detected on a link to the master clock, and where the alarm is removed after a wait to restore time where the CRC errors not detected during the wait to restore time.

8. The network element of claim 1, wherein the BMCA is performed based on the clock class stability where an alarm is raised when a certain number of clock class flops are detected on the master clock, and where the alarm is removed after a wait to restore time where the clock class flops are not detected during the wait to restore time.

9. A method implemented in a packet network, the method comprising steps of:
communicating with a master clock for Precision Time Protocol (PTP);
monitoring one or more of link stability to the master clock, errors in packets to the master clock, and clock class stability of the master clock; and
performing a Best Master Clock Algorithm (BMCA) based on the monitored one or more of the link stability, the errors, and the clock class stability.

10. The method of claim 9, wherein the BMCA is further performed based on one or more of loss of synchronization messages, loss of announce messages, loss of follow up messages, unusable timing information, and a holdover mode.

11. The method of claim 9, wherein the monitored one or more of the link stability, the errors, and the clock class stability are each a PTP Telecom Synchronization Fail (PTSF) alarm.

12. The method of claim 9, wherein the BMCA is performed responsive to an alarm for the monitored one or more of the link stability, the errors, and the clock class stability.

13. The method of claim 9, wherein the BMCA is performed based on the link stability where an alarm is raised when a quality issue of a link to the master clock is detected, and where the alarm is removed after a wait to restore time where the quality issue is not detected during the wait to restore time.

14. The method of claim 13, wherein the quality issue is based on any of packet loss, latency, jitter, and throughput consistency.

15. The method of claim 9, wherein the BMCA is performed based on the errors which are Cyclic Redundancy Check (CRC) where an alarm is raised when a certain number of CRC errors are detected on a link to the master clock, and where the alarm is removed after a wait to restore time where the CRC errors not detected during the wait to restore time.

16. The method of claim 9, wherein the BMCA is performed based on the clock class stability where an alarm is raised when a certain number of clock class flops are detected on the master clock, and where the alarm is removed after a wait to restore time where the clock class flops are not detected during the wait to restore time.

17. A non-transitory computer-readable medium comprising instructions that, when executed, cause circuitry to perform steps of:
communicating with a master clock for Precision Time Protocol (PTP);
monitoring one or more of link stability to the master clock, errors in packets to the master clock, and clock class stability of the master clock; and
performing a Best Master Clock Algorithm (BMCA) based on the monitored one or more of the link stability, the errors, and the clock class stability.

18. The non-transitory computer-readable medium element of claim 17, wherein the BMCA is further performed based on one or more of loss of synchronization messages, loss of announce messages, loss of follow up messages, unusable timing information, and a holdover mode.

19. The non-transitory computer-readable medium of claim 17, wherein the monitored one or more of the link stability, the errors, and the clock class stability are each a PTP Telecom Synchronization Fail (PTSF) alarm.

20. The non-transitory computer-readable medium of claim 17, wherein the BMCA is performed responsive to an alarm for the monitored one or more of the link stability, the errors, and the clock class stability.
